(19) United States
(12) Patent Application Publication
(10) Pub. No.: US 2026/0141665 A1
(43) Pub. Date: May 21, 2026

(54) WELDING DEVICE

(71) Applicant: Coretronic Intelligent Robotics Corporation, Hsin-Chu (TW)

(72) Inventor: Chia-Chang Lee, Hsin-Chu (TW)

(73) Assignee: Coretronic Intelligent Robotics Corporation, Hsin-Chu (TW)

(21) Appl. No.: 19/378,194

(22) Filed: Nov. 3, 2025

(30) Foreign Application Priority Data
Nov. 21, 2024 (CN) 202422841770.0

(51) Int. Cl. G06V 10/145; B23K 37/00

(52) U.S. Cl. CPC G06V 10/145; B23K 37/00; G06V 2201/06

(57) ABSTRACT

A welding device including a housing, a welding module, and at least one visual recognition module is provided. The welding module includes a welding head. The welding head is disposed on a first area of the housing. The visual recognition module is disposed on a second area of the housing. Each visual recognition module includes a camera lens and an image sensor, and an optical axis of the camera lens does not pass through a center of the image sensor. The first area is different from the second area.

### CROSS-REFERENCE TO RELATED APPLICATION

This application claims the priority benefit of China application serial no. 202422841770.0 filed on Nov. 21, 2024. The entirety of the above-mentioned patent application is hereby incorporated by reference herein and made a part of this specification.

### BACKGROUND OF THE INVENTION

### Field of the Invention

The invention relates to a welding device.

### Description of Related Art

In a general welding device, such as a welding robot, in order to confirm whether the welding head is correctly welding to the object to be welded and monitor the welding process, the welding head and a welding joint of the object to be welded are photographed via a visual recognition module. Since the welding head is generally located in the center of the welding device, and the visual recognition module is disposed at a side of the welding head, the optical axis of the visual recognition module is configured to be tilted relative to the central axis of the welding head to allow the visual recognition module to take a picture of the welding joint. Since the optical axis of the visual recognition module is not parallel to the central axis of the welding head, the object to be welded is not on the object plane of the visual recognition module. Therefore, the image captured by the visual recognition module is defocused and has conditions such as keystone, which may cause the visual recognition module to misjudge and further reduce the accuracy of the welding process.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY OF THE INVENTION

The invention provides a welding device having simple member positioning and high welding process precision.

Other objects and advantages of the invention may be further understood from the technical features disclosed in the invention.

To achieve one, part, or all of the above objects or other objects, a welding device provided according to an embodiment of the invention includes a housing, a welding module, and at least one visual recognition module. The welding module includes a welding head. The welding head is disposed on a first area of the housing. The visual recognition module is disposed on a second area of the housing. Each visual recognition module includes a camera lens and an image sensor, and a first optical axis of the camera lens does not pass through a center of the image sensor. The first area is different from the second area.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1A shows a schematic diagram of a welding device according to an embodiment of the invention.

FIG. 1B shows a schematic diagram of an optical path architecture of the visual recognition module in FIG. 1A according to an embodiment.

FIG. 1C shows a schematic diagram of an optical path architecture of the lighting module in FIG. 1A according to an embodiment.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Unless limited otherwise, the terms “connected,” “coupled,” and “mounted,” and variations thereof herein are used broadly and encompass direct and indirect connections, couplings, and mountings. Accordingly, the drawings and descriptions will be regarded as illustrative in nature and not as restrictive.

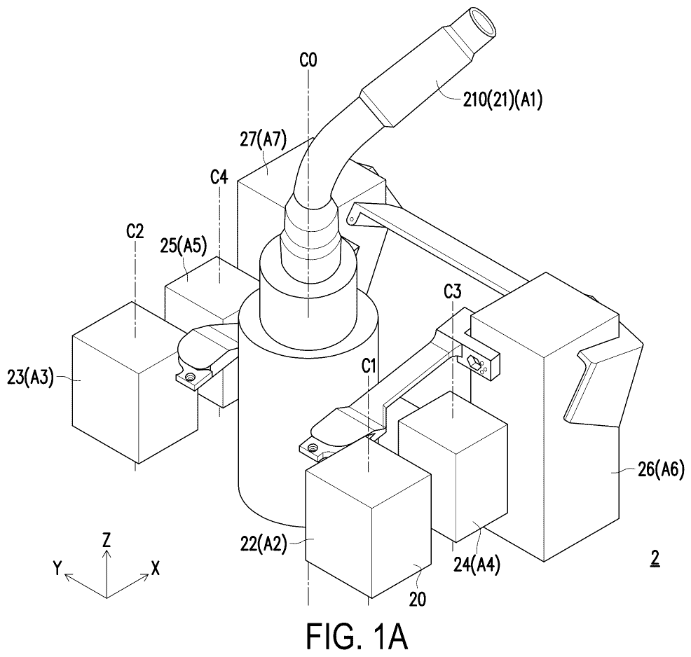

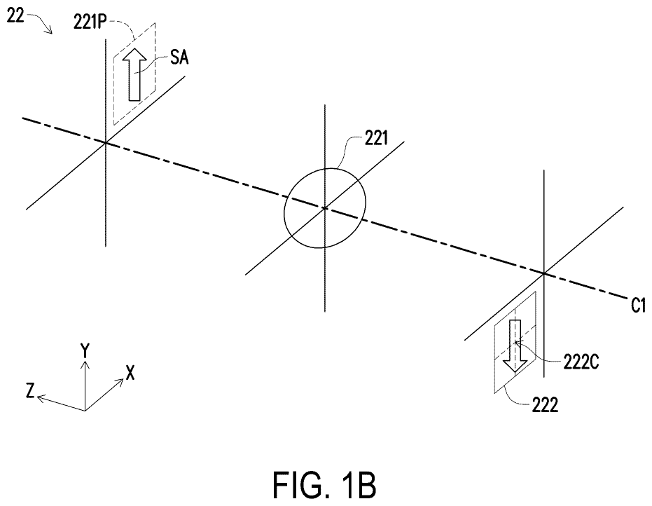

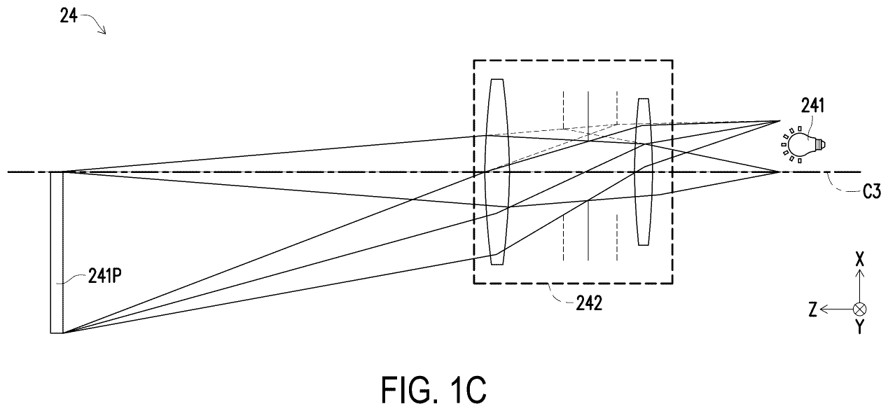

Please refer to FIG. 1A to FIG. 1C. FIG. 1A shows a schematic diagram of a welding device according to an embodiment of the invention. FIG. 1B shows a schematic diagram of an optical path architecture of the visual recognition module in FIG. 1A according to an embodiment. FIG. 1C shows a schematic diagram of an optical path architecture of the lighting module in FIG. 1A according to an embodiment.

A welding device 2 includes a housing 20, a welding module 21, visual recognition modules 22 and 23, lighting modules 24 and 25, and structured light lighting modules 26 and 27.

The welding module 21 includes a welding head 210. The welding head 210 is disposed on a first area A1 of the housing 20 and has a virtual central axis C0. The central axis C0 referred to herein is defined by the center of the position where the welding head 210 is connected to the housing 20. The visual recognition modules 22 and 23 are respectively disposed on second areas A2 and A3 of the housing 20. The lighting modules 24 and 25 are respectively disposed on third areas A4 and A5 of the housing 20. The structured light lighting modules 26 and 27 are respectively disposed on third areas A6 and A7 of the housing 20. In the present embodiment, the first area A1 is different from the second areas A2 and A3 and the third areas A4, A5, A6, and A7, and the third areas A4, A5, A6, and A7 are different from the first area A1 and different from the second areas A2 and A3. In the present embodiment, the number of the visual recognition module, the number of the lighting module, and the number of the structured light lighting module are 2 respectively, but the invention is not limited thereto. The structured light lighting modules 26 and 27 are suitable for emitting a light beam having a lighting pattern. The lighting pattern is a matrix distribution structure pattern, such as a dot matrix or a line matrix used as a reference mark when the visual recognition modules 22 and 23 take a picture of the welding joint to improve the accuracy of the welding process.

The visual recognition module 22 includes a camera lens 221 and an image sensor 222. It should be particularly noted that a first optical axis C1 of the camera lens 221 is configured not to pass through a center 222C of the image sensor 222. Specifically, the camera lens 221 is used to take an image of an object SA to be welded. The object SA to be welded may be the object to be welded, or the environment around the object to be welded, so as to improve the accuracy of the welding process. As shown in FIG. 1A and FIG. 1B, the welding head 210 is disposed on the first area A1 of the housing 20, and the visual recognition module 22 is disposed on the second area A2 of the housing 20. Therefore, the object to be welded or the environment around the object to be welded (i.e., the object SA to be welded) and the first optical axis C1 of the visual recognition module 22 are misaligned. By configuring the first optical axis C1 of the camera lens 221 not to pass through the center 222C of the image sensor 222, the object SA to be welded may be placed on an object plane 221P on the first optical axis C1 of the visual recognition module 22. When the visual recognition module 22 photographs the object SA to be welded on the object plane 221P on the first optical axis C1 of the camera lens 221, the image sensor 222 is located on an image plane on the first optical axis C1 of the camera lens 221, wherein the object plane 221P is parallel to the image plane (X-Y plane) where the image sensor 222 is located. Therefore, the image of the object SA to be welded on the image sensor 222 is clear, which is beneficial to improve the accuracy of the welding process.

It should also be noted that, in the embodiment shown in FIG. 1B, the object SA to be welded and the first optical axis C1 are misaligned on an X direction (i.e., the first direction) and a Y direction (i.e., the second direction), wherein the first optical axis C1 is parallel to a Z direction, and the X direction, the Y direction, and the Z direction are perpendicular to each other. Therefore, the center 222C of the image sensor 222 is disposed to be misaligned with the first optical axis C1 on the X direction and the Y direction.

Referring to FIG. 1A, by disposing the first optical axis C1 of the camera lens 221 to not pass through the center 222C of the image sensor 222, the first optical axis C1 of the camera lens 221 may be parallel to the central axis C0 of the welding head 210 (i.e., the first optical axis C1 of the camera lens 221 is not tilted relative to the central axis C0 of the welding head 210). Compared with the welding devices in the prior art, the members of the welding device 2 of the present embodiment are simply positioned, thus significantly reducing manufacturing cost and maintenance cost.

Referring to FIG. 1A, the visual recognition module 23 has the same optical path architecture as the visual recognition module 22, and is not described in detail herein. Furthermore, a first optical axis C2 of a camera lens (not depicted) of the visual recognition module 23 is parallel to the first optical axis C1 of the visual recognition module 22. By providing the visual recognition module 22 and the visual recognition module 23, the visual recognition range of the welding device 2 may be increased, thereby improving the accuracy of the welding process.

Referring to FIG. 1A and FIG. 1C, the lighting module 24 may be used to illuminate the object to be welded of the welding device 2 or the environment around the object to be welded.

According to some embodiments of the invention, as shown in FIG. 1C, the lighting module 24 includes a light source 241 and a lens group 242. The light source 241 may be disposed off-axis relative to a second optical axis C3 of the lens group 242. Accordingly, a lighting area 241P of the lighting module 24 may be misaligned with the second optical axis C3 of the lens group 242. The lighting module 24 accurately illuminates the object to be welded and the surrounding area thereof (i.e., the object SA to be welded) to improve the visual recognition accuracy of the visual recognition modules 22 and 23 and the welding quality of the welding device 2. In these embodiments, the second optical axis C3 of the lighting module 24 may be parallel to the first optical axis C1 of the visual recognition module 22, the first optical axis C2 of the visual recognition module 23, and the central axis C0 of the welding head 210. Therefore, the positioning of the members of the welding device 2 is simple, thus significantly reducing manufacturing cost and maintenance cost. The lighting module 25 has the same internal structure as the lighting module 24, and is not described in detail herein. Furthermore, a second optical axis C4 of the lens group (not depicted) of the lighting module 25 is parallel to the second optical axis C3 of the lighting module 24. By providing the lighting module 24 and the lighting module 25, sufficient and uniform lighting may be provided to the object to be welded and the surrounding area thereof, thereby improving the accuracy of the welding process.

However, the invention is not limited thereto. According to some embodiments, the light source 241 in FIG. 1C is disposed on the second optical axis C3 of the lens group 242 and directed toward the object to be welded of the welding device 2 or the environment (i.e., the object SA to be welded) around the object to be welded by tilting the lighting module 24 for illumination. In these embodiments, the second optical axis C3 (and the second optical axis C4 of the lighting module 25) of the lighting module 24 may be not parallel to the first optical axis C1 of the visual recognition module 22, the first optical axis C2 of the visual recognition module 23, and the central axis C0 of the welding head 210.

Based on the above, the welding device of an embodiment of the invention has at least one of the following advantages: (1) the object to be welded of the visual recognition module is positioned on the object plane of the visual recognition module, and the object to be welded is clearly imaged on the image sensor; (2) the visual recognition module is not tilted relative to the central axis of the welding head; (3) the lighting module is not tilted relative to the central axis of the welding head; and (4) the members of the welding device are readily positioned, thus significantly reducing manufacturing cost and maintenance cost.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The use of “at least one of . . . and . . . ” thereof herein may include “one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A welding device, comprising:
a housing;
a welding module comprising a welding head, and the welding head is disposed on a first area of the housing; and
at least one visual recognition module disposed on a second area of the housing, wherein each of the at least one visual recognition module comprises a camera lens and an image sensor, a first optical axis of the camera lens does not pass through a center of the image sensor, and the first area is different from the second area.

2. The welding device of claim 1, further comprising at least one lighting module, wherein the at least one lighting module is disposed on a third area of the housing, each of the at least one lighting module comprises a light source and a lens group, and the light source is disposed off-axis relative to a second optical axis of the lens group.

3. The welding device of claim 2, wherein the first optical axis is parallel to the second optical axis.

4. The welding device of claim 1, further comprising at least one lighting module, wherein the at least one lighting module is disposed on a third area of the housing, the at least one lighting module comprises a light source and a lens group, and the light source is located on a second optical axis of the lens group.

5. The welding device of claim 4, wherein the first optical axis is not parallel to the second optical axis.

6. The welding device of claim 1, wherein the at least one visual recognition module comprises a first visual recognition module and a second visual recognition module, and the first optical axis of the camera lens of the first visual recognition module is parallel to the first optical axis of the camera lens of the second visual recognition module.

7. The welding device of claim 1, further comprising at least one structured light lighting module disposed on a third area of the housing, and the third area is different from the first area and the second area.

8. The welding device of claim 7, wherein the at least one structured light lighting module is suitable for emitting a light beam having a lighting pattern, and the lighting pattern is a matrix distribution structure pattern.

9. The welding device of claim 1, wherein the at least one visual recognition module is suitable for photographing an object to be welded on an object plane located on the first optical axis of the camera lens, the image sensor is located on an image plane on the first optical axis of the camera lens, and the object plane is parallel to the image plane.

10. The welding device of claim 1, wherein the center of the image sensor and the first optical axis are misaligned on a first direction and a second direction perpendicular to the first optical axis, and the first direction is perpendicular to the second direction.
